(19) United States
(12) Patent Application Publication
(10) Pub. No.: US 2007/0262717 A1
(43) Pub. Date: Nov. 15, 2007

(54) Plasma display panel

(76) Inventors: Masashi Ohta, Miyazaki (JP); Tatsuhiko Kawasaki, Miyazaki (JP); Takashi Sasaki, Hiratsuka (JP)

Correspondence Address: MCDERMOTT WILL & EMERY LLP, 600 13TH STREET, N.W., WASHINGTON, DC, 20005-3096, US

(21) Appl. No.: 11/714,915

(22) Filed: Mar. 7, 2007

(30) Foreign Application Priority Data
May 11, 2006 (JP) 2006-132652

(51) Int. Cl. H01J 17/49

(52) U.S. Cl. 313/582

(57) ABSTRACT

A plasma display panel includes: a front substrate having a sustain electrode and a scan electrode for causing surface discharge, and a first dielectric layer which covers the sustain electrode and the scan electrode; a rear substrate having an address electrode extending across the sustain electrode and the scan electrode, and a second dielectric layer which covers the address electrode; a partition wall disposed in a discharge space defined between the front substrate and the rear substrate combined together and partitioning the discharge space; and a fluorescent layer covering a side surface of the partition wall and the second dielectric layer; wherein the second dielectric layer has a light absorbing function, and the partition wall has a light transmitting function. The plasma display panel ensures higher brightness and higher contrast.

### CROSS-REFERENCE TO RELATED APPLICATION

This application is related to Japanese patent application No. 2006-132652 filed on May 11, 2006 whose priority is claimed under 35 USC §119, the disclosure of which is incorporated by reference in its entirety.

### BACKGROUND OF THE INVENTION

1. Field of the Invention

The present invention relates to a plasma display panel.

2. Description of the Related Art

In recent years, AC-type flat plasma display devices adapted to cause surface discharge have been put into practical use, and widely employed as display devices for personal computers, work stations and the like, flat wall-hung TVs, and devices for displaying advertisement and information. Plasma display panels employing such plasma display devices require improvement in contrast.

A typical surface discharge flat plasma display device is designed so that all pixels on a screen simultaneously emit light according to display data. The surface discharge plasma display device includes a plurality of electrodes provided on an inner surface of a front glass substrate for causing surface discharge. When a voltage is applied between paired ones of the electrodes, the surface discharge occurs on surfaces of a dielectric layer and a protection layer provided over the electrodes to generate ultraviolet radiation. Fluorescent materials of three primary colors, i.e., red (R), green (G) and blue (B), applied on an inner surface of a rear glass substrate are excited by the ultraviolet radiation to emit light. Thus, full color display is achieved.

In the full color plasma display panel, cells each include a fluorescent layer formed by selectively applying the red, green or blue fluorescent material therein according to the color of light to be emitted therefrom. Ultraviolet radiation generated in a discharge space in each of the cells impinges on the fluorescent layer, which in turn emits the color light. In addition to the light emitted from the fluorescent layer, external light reflected on the display panel is observed on a viewing side (display surface). That is, light incident on the cell from the outside is reflected on the fluorescent layer and a dielectric layer provided on the rear substrate. The reflected light increases the brightness of a displayed black image portion to reduce the contrast. A know method for improving the image quality of the plasma display panel is to provide a light absorbing layer on the viewing side of the panel (see, for example, Japanese Unexamined Patent Publication No. HEI 8(1996)-287832). This patent publication also discloses a dielectric layer having a light absorbing function to reduce the external light reflection.

Further, a known method for effectively extracting the emitted light is to provide a wavelength-selective reflection film on a rear surface of the display panel for reflecting the emitted light (see, for example, Japanese Unexamined Patent Publication No. HEI 8(1996)-138559). This patent publication also discloses a wavelength-selective reflection film provided on a rear surface of the fluorescent layer for reflecting the light emitted rearward from the fluorescent layer.

It is also known to cover the fluorescent layer with a light absorbing layer (see, for example, Japanese Unexamined Patent Publication No. HEI 11(1999)-162357).

However, the plasma display panel of the prior art fails to provide sufficient brightness and contrast.

### SUMMARY OF THE INVENTION

According to the present invention, there is provided a plasma display panel, which comprises: a front substrate having a sustain electrode and a scan electrode for causing surface discharge, and a first dielectric layer which covers the sustain electrode and the scan electrode; a rear substrate having an address electrode extending across the sustain electrode and the scan electrode, and a second dielectric layer which covers the address electrode; a partition wall disposed in a discharge space defined between the front substrate and the rear substrate combined together and partitioning the discharge space; and a fluorescent layer covering a side surface of the partition wall and the second dielectric layer; wherein the second dielectric layer has a light absorbing function, and the partition wall has a light transmitting function.

According to the present invention, the second dielectric layer provided on the rear substrate has the light absorbing function, and the partition wall has the light transmitting function. Therefore, the brightness of emitted light is sufficiently greater in a sustain period than in a reset period, and external light incident through the partition wall is sufficiently absorbed by the second dielectric layer. This ensures display of images with higher brightness and higher contrast.

### BRIEF DESCRIPTION OF THE DRAWINGS

FIG. 1 is an exploded perspective view of a major portion of a plasma display panel according to the present invention.

FIG. 2 is a sectional view of a major portion of the plasma display panel shown in FIG. 1.

FIG. 3 is a block diagram illustrating a driving control system of the plasma display panel shown in FIG. 1.

FIG. 4 is a diagram for explaining an exemplary gradation driving sequence to be performed in the plasma display panel shown in FIG. 1.

FIGS. 5(a) to 5(e) are diagrams illustrating exemplary driving waveforms to be generated by the driving control system of the plasma display panel shown in FIG. 3.

FIG. 6 is a diagram for explaining effects of a partition wall and a dielectric layer on light emitted within the inventive plasma display panel.

FIG. 7 is a diagram for explaining reset discharge caused in the inventive plasma display panel.

FIG. 8 is a diagram for explaining sustain discharge caused in the inventive plasma display panel.

FIG. 9 is a graph showing the results of measurement of brightness ratios of reset light emission and sustain light emission in the inventive plasma display panel.

### DETAILED DESCRIPTION OF THE INVENTION

A plasma display panel of the present invention includes: a front substrate having a sustain electrode and a scan electrode for causing surface discharge, and a first dielectric layer which covers the sustain electrode and the scan electrode; a rear substrate having an address electrode extending across the sustain electrode and the scan electrode, and a second dielectric layer which covers the address electrode; a partition wall disposed in a discharge space defined between the front substrate and the rear substrate combined together, and partitioning the discharge space; and a fluorescent layer covering a side surface of the partition wall and the second dielectric layer; wherein the second dielectric layer has a light absorbing function, and the partition wall has a light transmitting function.

The second dielectric layer may have a light absorption ratio of not less than 60%.

The second dielectric layer may include a black pigment of an oxide of a metal selected from the group consisting of iron, manganese and chromium.

A portion of the fluorescent layer present on the second dielectric layer may have a thickness of not greater than 25 μm.

The partition wall may be a structure formed by firing a paste consisting essentially of a glass frit, and comprising a PbO matrix glass material as a major component thereof, and 2 to 3 wt % of a glass material having a softening point lower by 10 to 100° C. than that of the PbO matrix glass material.

The light absorbing function may include a function of absorbing light reflected from a back side of the fluorescent layer toward a front side of the panel and light incident through the partition wall from the outside and reflected on the rear substrate.

The light transmitting function may include a function of transmitting light emitted from a portion of the fluorescent layer present on the partition wall toward a front side of the panel.

With reference to the attached drawings, the present invention will hereinafter be described in detail by way of an embodiment thereof.

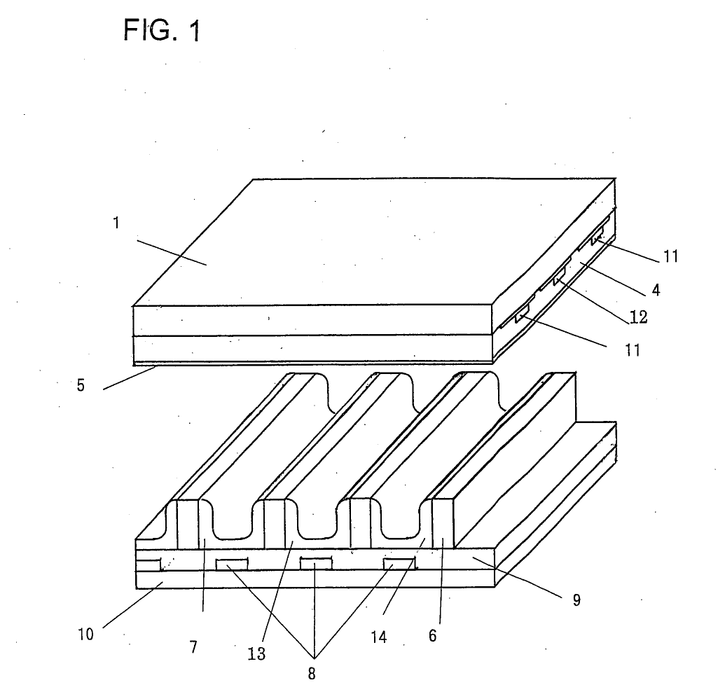

FIG. 1 is an exploded perspective view illustrating the construction of an inventive plasma display panel by way of example. Sustain electrodes 11 and scan electrodes 12 for causing surface discharge are disposed parallel to each other in alternating relation on a front substrate 1. These electrodes are covered with a first dielectric layer 4, which is in turn covered with a protection layer 5 such as of MgO. Address electrodes 8 are disposed on a rear substrate 10 as extended generally perpendicularly to the sustain electrodes 11 and the scan electrodes 12, and covered with a second dielectric layer 9. On the second dielectric layer 9, a plurality of partition walls 6 are disposed parallel to each other in a stripe pattern on opposite sides of the address electrodes 8 to define discharge spaces each extending in a row direction. Further, fluorescent layers 7, 13, 14 which are excited by ultraviolet radiation to emit visible light rays of red (R), green (G) and blue (B) are each provided over an upper surface portion of the second dielectric layer 9 on the address electrode 8 and side surfaces of the adjacent partition walls 6. The front substrate 1 and the rear substrate 10 are combined together with apexes of the partition walls 6 in contact with the protection layer 5 and with the discharge spaces filled with a discharge gas such as Ne—Xe to provide the plasma display panel.

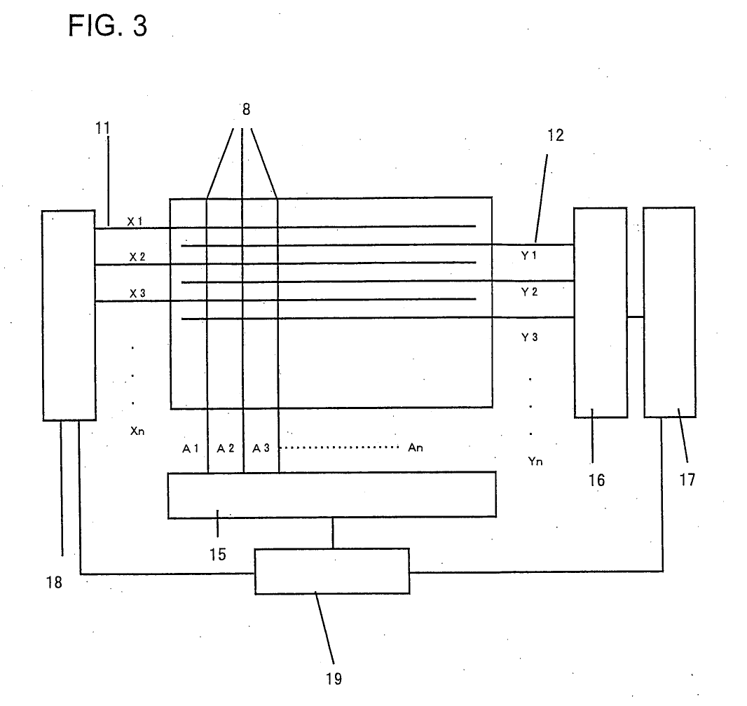

FIG. 3 is a block diagram illustrating a driving control system of the plasma display panel. The plasma display panel is connected to an X-drive circuit 18, a Y-drive circuit 16, a scan driver 17 and an address drive circuit 15 for applying voltages to the sustain electrodes 11, the scan electrodes 12 and the address electrodes 8. Further, a control circuit 19 is provided for controlling these circuits.

For example, multi-level image data (field data) indicating the brightness levels of three colors (R, G, B) is input to the control circuit 19 from an external device such as a TV tuner or a computer. Further, various synchronization signals (a clock signal CLK, a horizontal synchronization signal Hsync and a vertical synchronization signal Vsync) are input to the control circuit 19. Then, the control circuit 19 outputs proper signals to the respective drive circuits based on the field data and the synchronization signals to display a predetermined image.

In the plasma display panel, as shown in FIG. 3, the sustain electrodes 11 (X1, X2, X3, . . . ) for causing sustain discharge and the scan electrodes 12 (Y1, Y2, Y3, . . . ) are disposed in alternating relation to define display lines. The sustain electrodes 11, the scan electrodes 12 and the address electrodes 8 (A1, A2, A3, . . . ) extending perpendicularly to the sustain electrodes 11 and the scan electrodes 12 define display cells arranged in a matrix.

In an address period, the scan driver 17 successively applies scan pulses to the scan electrodes 12 to select each of the scan electrodes (display lines), whereby address discharge is selectively caused between the scan electrodes 12 and the address electrodes 8 connected to the address drive circuit 15 for selectively turn on and off the cells. In a sustain period, the Y-drive circuit 16 and the X-drive circuit 18 cause the sustain discharge in a cell selected by the address discharge.

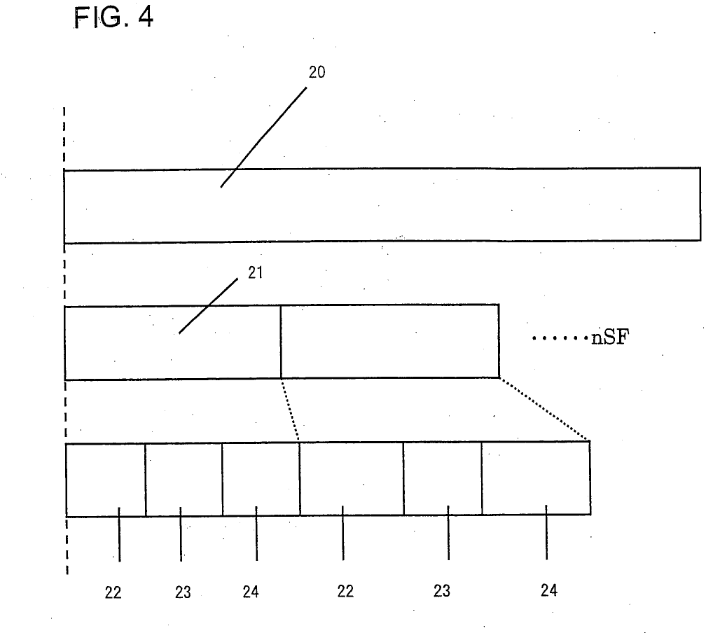

FIG. 4 is a diagram for explaining an exemplary gradation driving sequence to be performed by the drive control system in the plasma display panel of FIG. 1.

In the gradation driving sequence, as shown in FIG. 4, each field (frame) 20 includes a plurality of subfields (sub-frames) 21 (SF1 to SFn) each having a predetermined brightness weight, and a desired gradation level is displayed by a combination of the subfields. More specifically, eight subfields SF1 to SF8, for example, are defined as respectively having brightness weights of the n-th powers (n=0 to 7) of 2 (with a ratio of the number of times of the sustain discharge of 1:2:4:8:16:32:64:128) to permit display of 256 gradation levels. Of course, the number of the subfields and the weights of the respective subfields may be defined in any other combinations.

The subfields each involve an initialization cycle (reset period 22) for leveling out wall charges in all the cells in a display area, an address cycle (address period 23) for selecting cells to be turned on, and a display cycle (sustain period 24) for causing discharge in each of the selected cells (or turning on each of the selected cells) a number of times which depends on a required brightness level (or the weight of the subfield). For display of each of the subfields, the cells are selectively turned on according to the required brightness levels. For example, the eight subfields (SF1 to SF8) are displayed for display of each field.

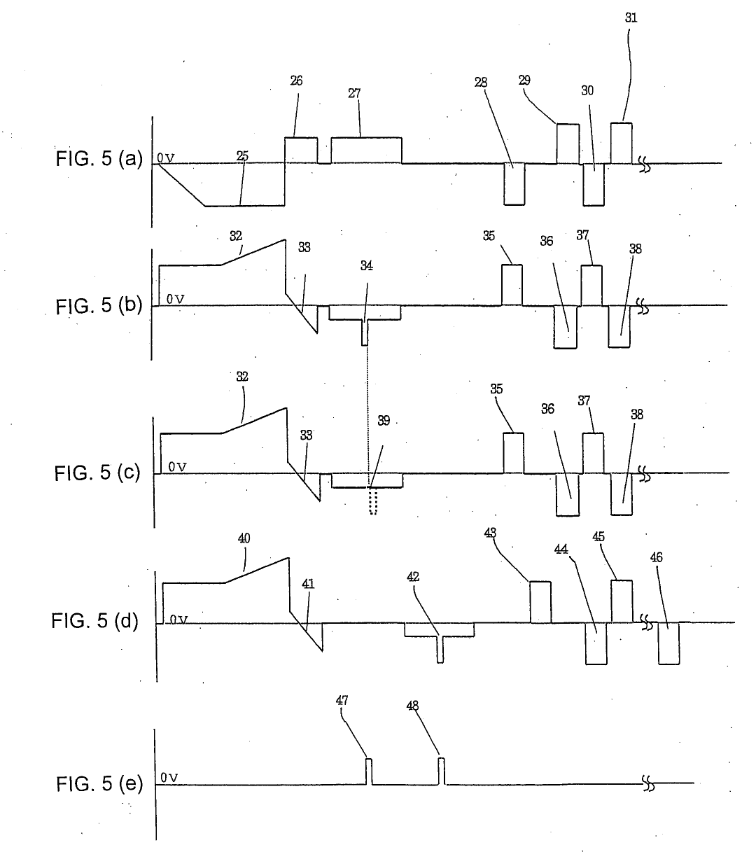

FIGS. 5(a) to 5(e) are diagrams illustrating exemplary driving waveforms. More specifically, FIGS. 5(a) to 5(e) respectively illustrate exemplary driving waveforms to be applied to the sustain electrode X1, the scan electrodes Y1, Y3, Y2 and the address electrode shown in FIG. 3 during a period from the reset period 22 to the sustain period 24 shown in FIG. 4. Numerals affixed to X and Y each indicate a line number. In FIGS. 5(a) to 5(e), the waveforms are applied to cause discharge between two electrodes X, Y affixed with the same numeral. The electrodes Y1, Y3 are representatives of odd-line scan electrodes, and the electrode Y2 is a representative of even-line scan electrodes.

As shown in FIGS. 5(a) and 5(b), an X-voltage 25 and a Y-writing dull-waveform voltage 32 are respectively applied to the sustain electrode X1 and the scan electrode Y1 for generating wall charges in all cells, and then an X-compensation voltage 26 and a Y-compensation dull-waveform voltage 33 are applied for substantially erasing the wall charges in the cells with a required amount of the charges left in the reset period.

In the subsequent address period, a scan pulse 34 is applied for causing discharge for selecting odd-line cells to be turned on, and an X-voltage 27 is applied for generating electric charges by this discharge. The timing of the application of the scan pulse 34 is shifted for each line. In the subsequent sustain period, first sustain pulses 28, 35, charge polarity control pulses 29, 36 and repetitive sustain pulses 30, 31, 37, 38 are applied.

FIG. 5(c) shows a voltage waveform applied to the scan electrode Y3. This voltage waveform is substantially the same as the voltage waveform applied to the scan electrode Y1 shown in FIG. 5(b) except for the timing of the application of the scan pulse 39. Where none of line cells on the scan electrode Y3 is to be turned on, there is no need to apply the scan pulse 39. This reduces the driving time. In this case, no voltage is applied to any of the address electrodes, and the voltage applied to the sustain electrode is constant in the address period. Therefore, the reduction in the driving time is easy.

FIG. 5(d) shows a voltage waveform applied to the scan electrode Y2. In the reset period, a Y-writing dull-waveform voltage 40 is applied to the scan electrode Y2 for generating electric charges in all cells, and then a Y-compensation dull-waveform voltage 41 is applied for substantially erasing the charges in the cells with a required amount of the charges left.

In the subsequent address period, a scan pulse 42 is applied for causing discharge for selecting even-line cells to be turned on. The timing of the application of the scanning pulse 42 is shifted for each line. In the subsequent sustain period, a first sustain pulse 43, repetitive sustain pulses 44, 45 and a discharge number control pulse 46 are applied.

FIG. 5(e) shows a voltage waveform applied to the address electrodes 8 in the address period and including address pulses 47, 48 for causing discharge for selecting row cells to be turned on. The application of the address pulses is synchronized with the application of the scan pulse for each line for causing discharge in cells disposed at intersections of the scan electrode 12 and the address electrodes 8 of interest.

In the last stage of the sustain period, a voltage waveform for erasing the wall charges may be added to the aforementioned driving waveforms.

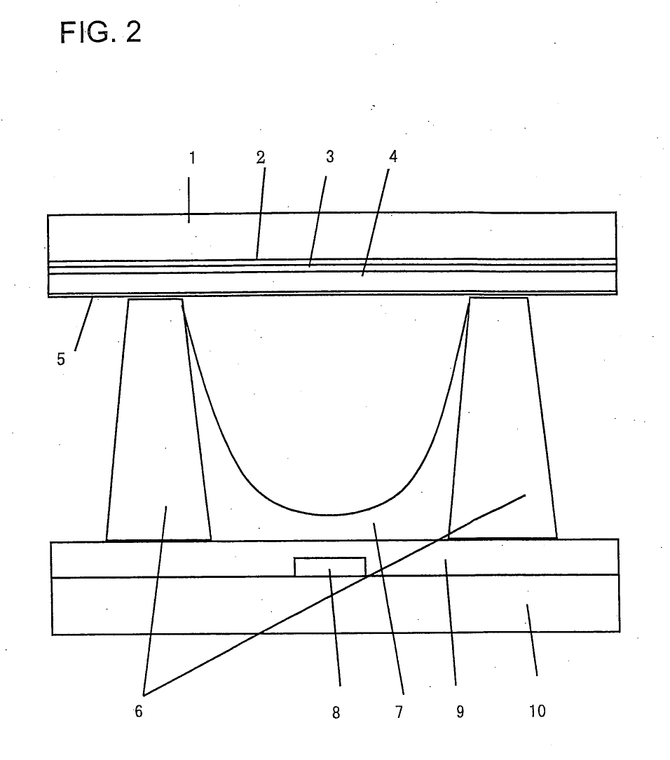

Features of this embodiment will be described with reference to FIG. 2. FIG. 2 is a sectional view of a major portion of the AC plasma display panel of FIG. 1 taken along the sustain (or scan) electrode. On the front substrate 1, the sustain electrodes and the scan electrodes are disposed parallel to each other in alternating relation. The sustain electrodes and the scan electrodes each include a transparent electrode 2 such as of ITO or tin oxide (SnO₂) and a bus electrode 3 of an electrode thin film such as of silver (Ag) or copper (Cu) provided on the transparent electrode 2.

These electrodes are covered with the dielectric layer (first dielectric layer) 4, which is in turn covered with the protection layer 5. The dielectric layer 4 is composed of a lower melting point glass material or the like, while the protection layer 5 is composed of magnesium oxide (MgO) or the like. The layout of the dielectric layer 4 and the protection layer 5 varies depending on a driving method, and does not directly influence the effects of the invention. On the rear substrate 10, the address electrodes 8 are provided as extending generally perpendicularly to the sustain electrodes and the scan electrodes provided on the front substrate 1, and the light absorbing dielectric layer (second dielectric layer) 9 is provided over the address electrodes 8.

The light transmitting partition walls 6 are disposed on the light absorbing dielectric layer 9 on the opposite sides of the address electrodes 8 to define the discharge spaces each extending in a row direction. The fluorescent layers (herein represented by the red fluorescent layer 7), which are each excited by ultraviolet radiation to emit visible light rays of red (R), green (G) or blue (B), are provided over the upper surface portions of the light absorbing dielectric layer 9 and the side surfaces of the light transmitting partition walls 6.

As described above, the front substrate 1 and the rear substrate 10 are combined together with the protection layer 5 in contact with the light transmitting partition walls 6, and the space defined between the front substrate 1 and the rear substrates 10 is filled with an inert gas such as helium (He), neon (Ne), argon (Ar) or xenon (Xe) at a pressure of 66.4 kPa (500 Torr). Thus, the plasma display panel is provided.

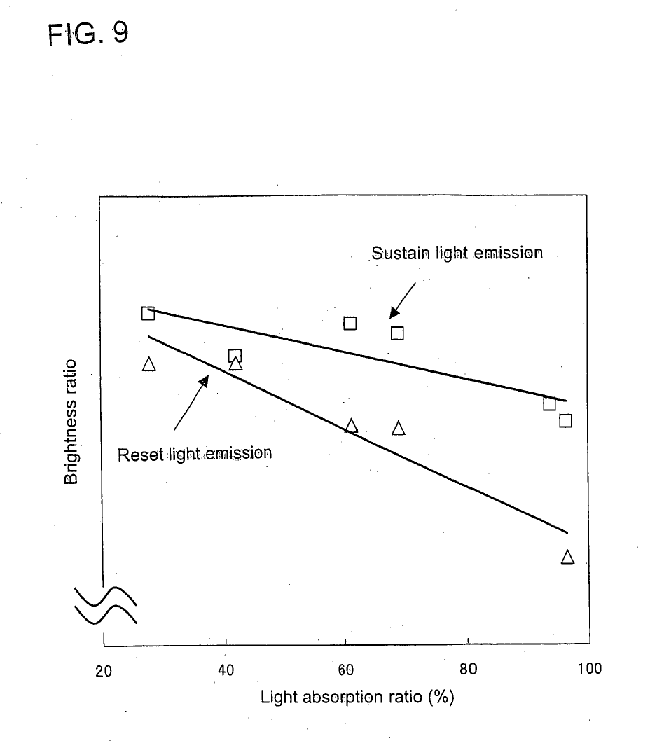

FIG. 9 shows the results of measurement of brightness ratios of light emission caused by reset discharge and light emission caused by the sustain discharge with respect to a varying light absorption ratio measured on the rear surface of the fluorescent layer in the plasma display panel including the light transmitting partition walls 6 shown in FIG. 2. The abscissa and the ordinate respectively represent the light absorption ratio measured on the rear surface of the fluorescent layer and the brightness ratios of the reset light emission and the sustain light emission. The brightness ratios of the reset light emission and the sustain light emission are plotted in the graph.

A comparison between the sustain light emission and the reset light emission shows that the brightness ratio of the reset light emission is lower than the brightness ratio of the sustain light emission with a difference therebetween increasing with the light absorption ratio. The difference between the reset light emission and the sustain light emission is significant at a light absorption ratio of not less than 60% as measured on the rear surface of the fluorescent layer. As can be understood from the results shown in FIG. 9, the light absorption ratio of the light absorbing dielectric layer 9 is preferably not less than 60%.

The light absorbing dielectric layer 9 is black or dark in color, and free from or substantially free from light transmission. The light absorbing dielectric layer 9 is formed of a mixture of a conventionally known dielectric layer material such as a lower melting point glass material and a black pigment of an oxide of a metal such as iron (Fe), manganese (Mn) or chromium (Cr).

Where a portion of the fluorescent layer present on the light absorbing dielectric layer 9 has a thickness of not greater than 25 μm, the AC plasma display panel including the light absorbing dielectric layer 9 and the light transmitting partition walls 6 is more effective. The reflectance and transmittance of the fluorescent layer in a visible wavelength range are determined by the particle density and thickness of the fluorescent layer. Where the fluorescent layer has a higher particle density or a greater thickness, the fluorescent layer has a lower transmittance and a higher reflectance. Fluorescent materials commonly used for plasma displays generally have particle diameters of about 1.5 to 3 μm. An experiment conducted with the use of a fluorescent material having the smallest particle diameters among these fluorescent materials reveals that the panel viewing side reflectivity is saturated when the thickness is 25 μm or greater. Therefore, the fluorescent layers preferably each have a thickness of not greater than 25 μm for improving the effectiveness of the present invention.

The panel viewing side reflectivity is herein defined as a reflectivity measured on the viewing side of the front substrate 1.

The light transmitting partition walls 6 preferably each have a transmittance of not less than 60% in the visible wavelength range. The light transmitting partition walls 6 may be formed of a mixture of a PbO matrix glass material as a major component and about 2 to about 3 wt % of a glass material having a softening point lower by about 10 to about 100° C. than that of the matrix glass material. In the plasma display panel shown in FIG. 1, the light transmitting partition walls 6 are provided on the rear substrate 10, but may be provided on the front substrate 1.

The features of this embodiment will be further described.

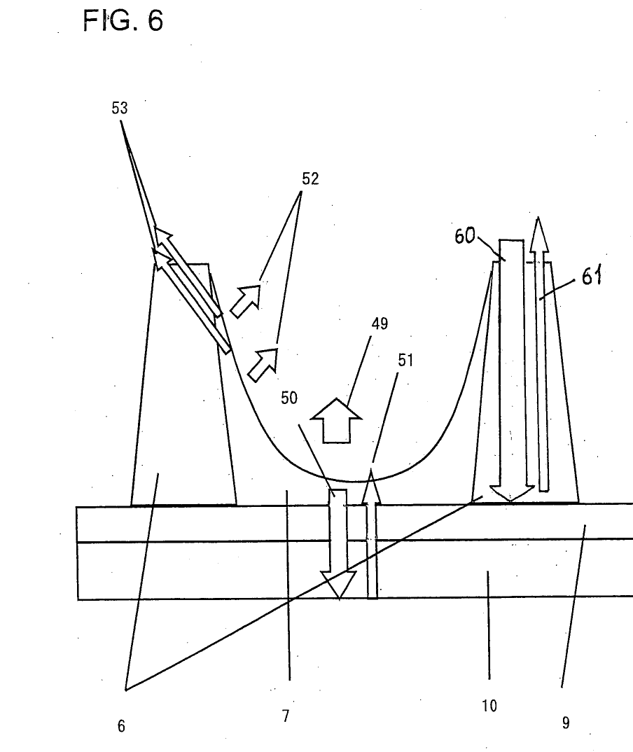

FIG. 6 shows effects of the partition walls and the dielectric layers on light emitted within the plasma display panel of FIG. 1 and light incident from the outside. Light rays mainly emitted from a surface portion of each of the fluorescent layers (herein represented by the fluorescent layer 7 (R)) are partly directed forward (upward in FIG. 6) as indicated by an arrow 49, and partly travel to the rear side of the fluorescent layer as indicated by an arrow 50.

The light rays 50 traveling to the rear side of the fluorescent layer reach the rear substrate 10, and are reflected forward through the fluorescent layer from the rear substrate 10 as indicated by an arrow 51. Further, light rays emitted from surface portions of the fluorescent layer present on the partition walls 6 are partly directed forward as indicated by arrows 52, and partly transmitted through the partition walls 6 as indicated by arrows 53.

The display light of the plasma display panel is a sum of the light rays 49 emitted from the surface portion of the fluorescent layer and directed forward (upward in FIG. 6), the light rays 51 reflected forward from the rear side of the fluorescent layer, the light rays 52 emitted from the portions of the fluorescent layer present on the partition walls and the light rays 53 transmitted through the partition walls 6. Further, the amount of light rays incident through the partition walls 6 from the outside as indicated by an arrow 60 and reflected as indicated by an arrow 61 significantly influences the contrast.

With the provision of the light absorbing dielectric layer 9 according to the present invention, the amount of the light rays traveling to the rear side of the fluorescent layer as indicated by the arrow 50 and reflected forward from the rear side of the fluorescent layer as indicated by the arrow 51 is reduced, and the amount of the light rays incident through the partition walls 6 from the outside as indicated by the arrow 60 and reflected as indicated by the arrow 61 is reduced. Further, with the provision of the light transmitting partition walls 6, the light rays transmitted through the partition walls as indicated by the arrows 53 are maximally utilized as a part of the display light. Thus, the brightness and the contrast are increased.

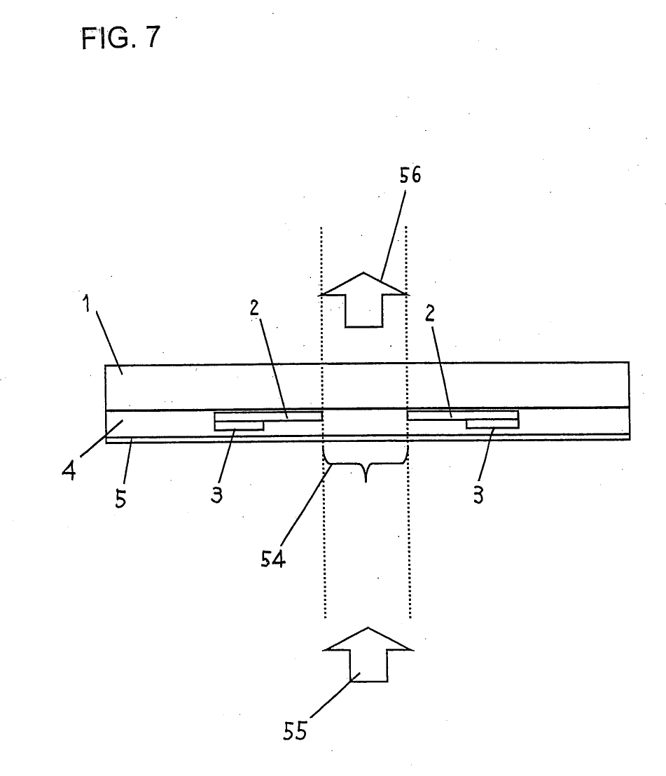

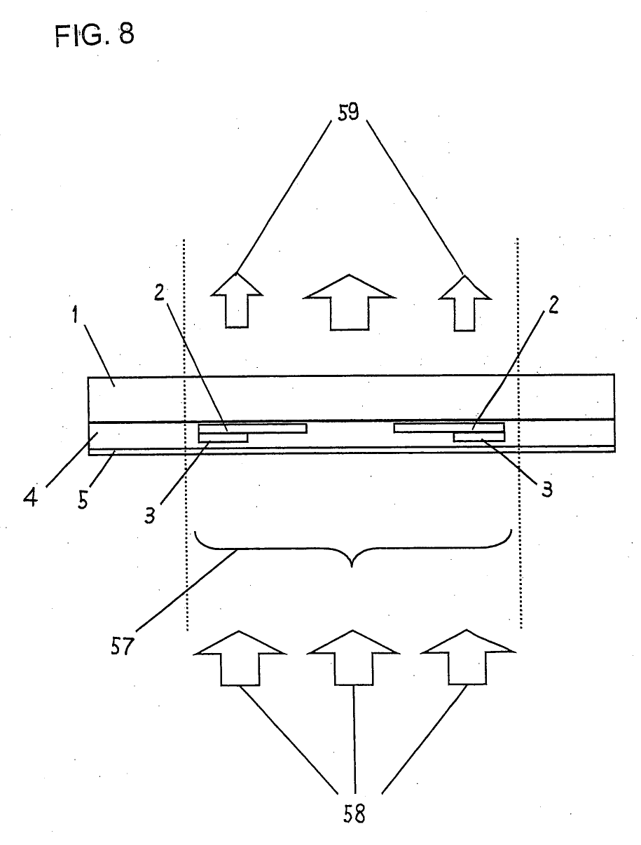

The features of this embodiment will be further described with reference to FIGS. 7 and 8. FIG. 7 is a partial sectional view of the panel of FIG. 2 taken parallel to the address electrodes 8, showing light emission caused by the reset discharge. The reset discharge occurs in a discharge gap defined between the transparent electrodes 2 of the sustain electrode 11 and the scan electrode 12 as indicated by a reference numeral 54.

An area of the fluorescent layer irradiated with ultraviolet radiation generated by the reset discharge 54 is relatively narrow because of the magnitude of the reset discharge 54. Therefore, light is emitted from the narrower surface area of the fluorescent layer by the reset discharge 54. In the reset period, light 55 which is a sum of the light rays 49 directed forward (upward in FIG. 6), the light rays 51 reflected forward from the rear side of the fluorescent layer, the light rays 52 emitted from the portions of the fluorescent layer present on the partition walls 6 and the light rays 53 transmitted through the partition walls 6 passes through the front substrate 1 to be outputted as display light 56 without being blocked by the bus electrodes 3 (see FIG. 7).

The provision of the light absorbing dielectric layer 9 reduces the amount of the light rays 51 reflected forward from the rear side of the fluorescent layer, thereby reducing the amount of the display light occurring due to the reset discharge 54.

FIG. 8 is a partial sectional view of the panel of FIG. 2 taken parallel to the address electrodes 8 similarly to FIG. 7, showing light emission caused by the sustain discharge. Unlike the reset discharge 54, the sustain discharge occurs in a broader region extending to the bus electrodes 2 as indicated by a reference numeral 57. Therefore, an area of the fluorescent layer irradiated with ultraviolet radiation generated by the sustain discharge 57 is wider than the area of the fluorescent layer irradiated with the ultraviolet ray generated by the reset discharge 54 (FIG. 7) because of the magnitude of the sustain discharge 57. Therefore, light is emitted from the wider surface area of the fluorescent layer by the sustain discharge 57.

In the sustain period, light 58 which is a sum of the light rays 49 directed forward (upward in FIG. 6), the light rays 51 reflected forward from the rear side of the fluorescent layer, the light rays 52 emitted from the portions of the fluorescent layer present on the partition walls 6 and the light rays 53 transmitted through the partition walls 6 is outputted as display light 59, though partly blocked by the bus electrodes 2. In the present invention, the amount of the display light 59 occurring in the sustain period is reduced, because the amount of the light reflected forward from the rear side of the fluorescent layer is reduced by the provision of the light absorbing dielectric layer 9 and the light occurring due to the sustain discharge 57 is blocked by the bus electrodes 2. However, the reduction in the display light is smaller during the sustain discharge than during the reset discharge.

As described above in detail, the present invention ensures higher brightness and higher contrast by employing the light absorbing dielectric layer 9 and the light transmitting partition walls 6 in combination.

The present invention is applicable to various types of plasma display devices. The invention will find wide application, for example, in display devices for personal computers, work stations and the like, flat wall-hung TVs, and devices for displaying advertisement and information.

What is claimed is:

1. A plasma display panel comprising:
a front substrate having a sustain electrode and a scan electrode for causing surface discharge, and a first dielectric layer which covers the sustain electrode and the scan electrode;
a rear substrate having an address electrode extending across the sustain electrode and the scan electrode, and a second dielectric layer which covers the address electrode;
a partition wall disposed in a discharge space defined between the front substrate and the rear substrate combined together, and partitioning the discharge space; and
a fluorescent layer covering a side surface of the partition wall and the second dielectric layer;
wherein the second dielectric layer has a light absorbing function, and the partition wall has a light transmitting function.

2. A plasma display panel as set forth in claim 1, wherein the second dielectric layer has a light absorption ratio of not less than 60%.

3. A plasma display panel as set forth in claim 1, wherein the second dielectric layer comprises a black pigment of an oxide of a metal selected from the group consisting of iron, manganese and chromium.

4. A plasma display panel as set forth in claim 1, wherein a portion of the fluorescent layer present on the second dielectric layer has a thickness of not greater than 25 μm.

5. A plasma display panel as set forth in claim 1, wherein the partition wall is a structure formed by firing a paste consisting essentially of a glass frit, and comprising a PbO matrix glass material as a major component thereof, and 2 to 3 wt % of a glass material having a softening point lower by 10 to 100° C. than that of the PbO matrix glass material.

6. A plasma display panel as set forth in claim 1, wherein the light absorbing function includes a function of absorbing light reflected from a back side of the fluorescent layer toward a front side of the panel and light incident through the partition wall from the outside and reflected on the rear substrate.

7. A plasma display panel as set forth in claim 1, wherein the light transmitting function includes a function of transmitting light emitted from a portion of the fluorescent layer present on the partition wall toward a front side of the panel.
